(19) United States
(12) Patent Application Publication
(10) Pub. No.: US 2009/0205921 A1
(43) Pub. Date: Aug. 20, 2009

(54) Torque Limiting Shaft Flange Assembly

(76) Inventors: Timothy M. Burns, Elbridge, NY (US); Sankar K. Mohan, Jamesville, NJ (US); Anupam Sharma, East Syracuse, NJ (US)

Correspondence Address: MAGNA INTERNATIONAL, INC., 337 MAGNA DRIVE, AURORA, ON, L4G-7K1, CA

(21) Appl. No.: 12/439,000

(22) PCT Filed: Aug. 14, 2007
(86) PCT No.: PCT/US07/17877

§ 371 Date: Feb. 26, 2009

Related U.S. Application Data
(60) Provisional application No. 60/841,510, filed on Aug. 31, 2006.

(51) Int. Cl. F16D 7/02

(52) U.S. Cl. 192/56.1

(57) ABSTRACT

A vehicle driveline that includes a first driveline component, which has a housing and a first power transmitting member, a second driveline component, which has a second power transmitting member, and a torque-limiting coupling that has a first clutch portion and a second clutch portion. The first clutch portion includes a first body that is removably coupled to the first power transmitting member for rotation therewith. The second clutch portion has a second body that is removably coupled to the second power transmitting member for rotation therewith. The second clutch portion is disposed outside the housing of the first driveline component. The torque-limiting coupling is configured to limit torque transmission between the first and second bodies. Related methods for operating a vehicle driveline and coupling vehicle driveline components are also provided.

The present disclosure generally relates to vehicle drivelines and more particularly to a coupling for limiting the transmission of drive torque in a driveline.

The drive torque provided through a vehicle drive line can vary widely based upon various vehicle and road conditions. In a conventional vehicle drive line, it is possible for the drive line to experience peaks in the transmission of drive torque that exceed two or three times the vehicle skid torque (also known as the vehicle slip torque). As will be appreciated, the use of components that are designed to handle two or three times the vehicle skid torque is disadvantageous in that these components (and therefore the vehicle) tend be more costly and heavy. Given that a vehicle's fuel economy is related to its weight, the weight of the vehicle drive line can be of particular significance.

### SUMMARY

In one form the present disclosure provides a method that includes: providing a first driveline component having an output member; coupling the output member to an input portion of a torque limiting coupling; and coupling an output portion of the torque limiting coupling to an input member of a second driveline component; wherein the first driveline component is selected from a group consisting of transmissions, propshafts, transfer cases, viscous couplings and differentials; wherein the second driveline component is selected from a group consisting of propshafts, transfer cases, viscous couplings and differentials; and wherein the second driveline component is different from the first driveline component.

In another form, the present disclosure provides a vehicle driveline that includes a first driveline component, which has a housing and a first power transmitting member, a second driveline component, which has a second power transmitting member, and a torque-limiting coupling that has a first clutch portion and a second clutch portion. The first clutch portion includes a first body that is removably coupled to the first power transmitting member for rotation therewith. The second clutch portion has a second body that is removably coupled to the second power transmitting member for rotation therewith. The second clutch portion is disposed outside the housing of the first driveline component. The torque-limiting coupling is configured to limit torque transmission between the first and second bodies.

In still another form the present disclosure provides a method that includes: providing a first driveline component having a first power transmitting member; directly coupling a first end of a coupling to the first power transmitting member of the first driveline component; directly coupling a second end of the coupling to a second power transmitting member of a second driveline component, the second power transmitting member being distinct from the first driveline component such that the first and second power transmitting members are not housed in a common housing; and permitting relative rotation between the first and second ends of the coupling to limit torque transmission between the first and second power transmitting members.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic illustration of a vehicle having an exemplary drivetrain constructed in accordance with the teachings of the present disclosure;

FIG. 2 is sectional view of a portion of the drivetrain of FIG. 1 illustrating the transfer case, front propshaft and torque-limiting coupling in greater detail;

FIG. 3 is an exploded perspective view of a portion of the drivetrain of FIG. 1; and

FIGS. 4 through 7 are schematic illustrations of portions of other vehicle drivetrains constructed in accordance with the teachings of the present disclosure.

### DETAILED DESCRIPTION OF THE VARIOUS EMBODIMENTS

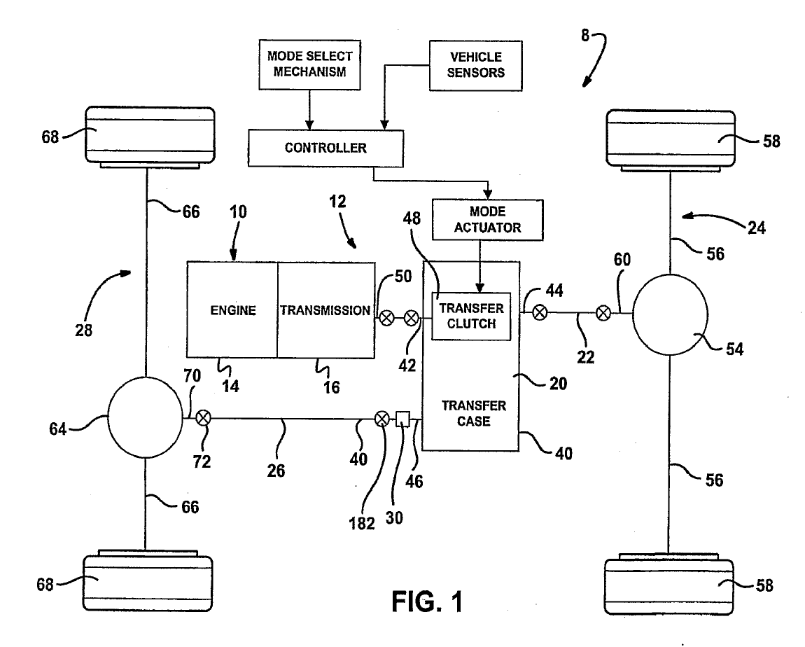

With reference to FIG. 1 of the drawings, an exemplary vehicle 8 can include a powertrain 10 and a drivetrain 12. The powertrain 10 can include a source of rotary tractive power (i.e., drive torque), such as an internal combustion engine 14, for producing drive torque that is transmitted to the drivetrain 12 to drive one or more sets of vehicle wheels. The drivetrain 12 can include a transmission 16, which can receive drive torque from the powertrain 10, a transfer case 20, a first propeller shaft 22, a first axle assembly 24, a second propeller shaft 26, a second axle assembly 28 and a torque-limiting coupling 30, which can couple the transfer case 20 to the second propeller shaft 26 in the particular example provided. While a transmission may be understood in the art as being associated with a vehicle powertrain rather than a drivetrain, it will be appreciated that for purposes of the present disclosure and appended claims, the transmission 16 is to be associated with the drivetrain 12 of the vehicle 8. It will also be appreciated that while the vehicle in the particular example provided employs a drivetrain with a four-wheel-drive arrangement, the teachings of the present disclosure have broader applicability. In this regard, a torque-limiting coupling constructed in accordance with the teachings of the present disclosure may be employed to interconnect a first vehicle drive line component with a second vehicle drive line component and to limit the transmission of torque therebetween. In the context of the present disclosure a drive line component could be any torque transmitting component in a vehicle drivetrain. Non-limiting examples of such drive line components can include transmissions, transfer cases, propeller shafts, viscous couplings, center differentials and the differentials of axial assemblies.

The transfer case 20 can be any type of transfer case, such as an electronically-controlled transfer case that permits a vehicle operator to select between a two-wheel drive mode, a locked (“part-time”) four-wheel drive mode, and an adaptive (“on-demand”) four-wheel drive mode. The transfer case 20 can have a housing 40, an input shaft 42, a first output shaft 44, a second output shaft 46 and a transfer clutch 48. An example of one such suitable transfer case is disclosed in U.S. Pat. No. 6,766,889, the disclosure of which is hereby incorporated by reference as if fully set forth in detail herein. Briefly, the housing 40 defines a cavity (not specifically shown) into which the input shaft 42, the first output shaft 44 and the second output shaft 46 are rotatably received. The input shaft 42 and the second output shaft 46 can extend from a first side of the housing 40, while the first output shaft 44 can extend from an opposite side of the housing 40. The input shaft 42 of the transfer case 20 can be coupled to an output shaft 50 of the transmission 16 to receive rotary power therefrom. The transfer clutch 48 can be selectively actuated for transferring drive torque from the first output shaft 44 to the second output shaft 46 for establishing the part-time and on-demand four-wheel drive modes.

The first axle assembly 24 can have a first differential 54 and a pair of axle shafts 56 that couple the first differential 54 to a pair of first wheels 58. The first differential 54 can include an input pinion 60 that can be coupled to the first output shaft 44 of the transfer case 20 via the first propeller shaft 22. The second axle assembly 28 can have a second differential 64 and a pair of axle shafts 66 that couple the second differential 64 to a pair of second wheels 68. The second differential 64 can include an input pinion 70 that can be coupled to the second propeller shaft 26 in a conventional and well known manner.

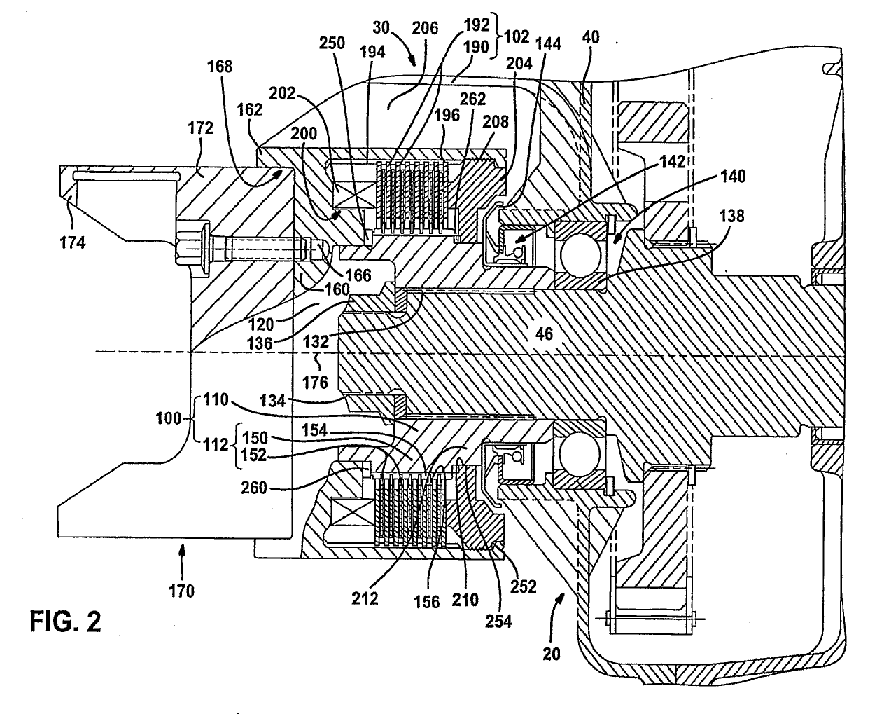

The torque-limiting coupling 30 can couple the second output shaft 46 of the transfer case 20 to the second propeller shaft 26. With additional reference to FIG. 2, the torque-limiting coupling 30 can include a first clutch portion 100 and a second clutch portion 102. The first clutch portion 100 can have a first body portion 110 and a first clutch structure 112 that can be coupled for rotation with the first body portion 110. The second clutch portion 102 can have a second body portion 120, which can be coupled for rotation with the second propeller shaft 26, and a second clutch structure 122 that can be coupled for rotation with the second body portion 120. The first and second clutch structures 112 and 122 can cooperate to form a torque-limiting clutch 130 that can limit the torque that is transmitted between the first and second body portions 110 and 120. In the particular example provided, torque-limiting clutch 130 is a friction clutch and more specifically, a dry friction clutch, but it will be appreciated that any appropriate type of torque-limiting clutch can be employed.

The first body portion 110 can be coupled for rotation with the second output shaft 46 of the transfer case 20 via a splined connection 132. A threaded fastener can be employed to removably couple the first body portion 110 to the second output shaft 46. In the particular example provided, the second output shaft 46 includes a threaded end segment 134 that is threadably engaged by a lock-nut 136 that cooperates with the threaded end segment 134 to apply a clamping force to fixedly but removably secure the first body portion 110 on the second output shaft 46 between the lock-nut 136 and another portion of the transfer case 20, such as the inner bearing race 138 of a bearing 140 that supports the second output shaft 46 for rotation in the housing 40. A lip seal 142 can be fitted to the housing 40 and can sealingly engage the first body portion 110 (or the second output shaft 46 in the alternative) to inhibit the egress of lubricant from the interior of the housing 40. In the particular example provided, the first body portion 110 includes a shield member 144 that is configured to shield the lip seal 142 from dirt and debris and also to form a sealing surface on which the lip seal 142 rides.

The first clutch portion 100 can include a first hub portion 150 and a plurality of first clutch plates 152. The first hub portion 150 can be rotary fixed coupled to the first body portion 110 and can include a plurality of longitudinally extending spline members, 154. The first clutch plates 152 can include a splined aperture 156 that non-rotatably but axially slidably engages the first hub portion 150 (i.e., the first clutch plates 152 can be splined to the first hub portion 150).

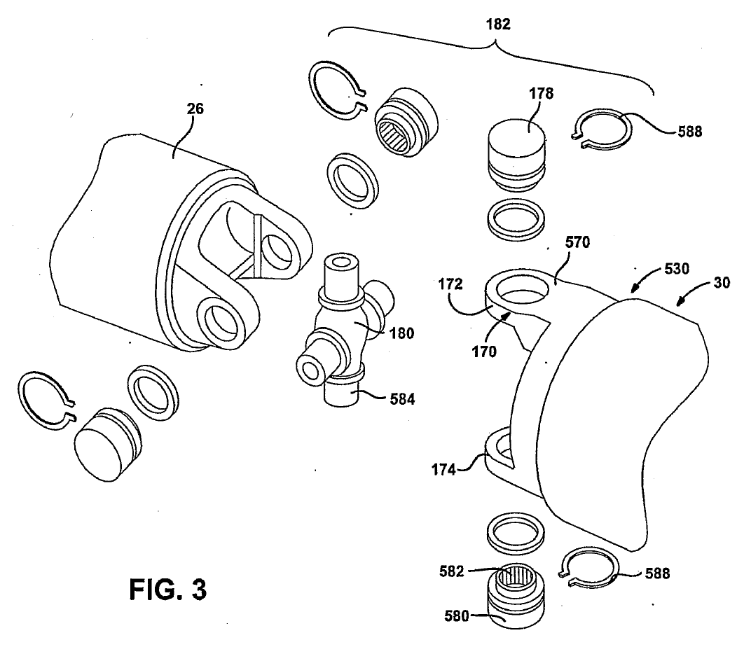

The second body portion 120 can include an annular hub 160 and a rim 162 that extends about the annular hub 160. The annular hub 160 can include a plurality of threaded apertures 166. The annular hub 160 and the rim 162 form a flange structure 168 that is configured to be coupled to a yoke flange 170. The yoke flange 170 can include a flange member 172 and a pair of yokes 174 that extend from the flange member 172. The flange member 172 is sized to be received in a slip-fit manner within the rim 162 of the second body portion 120 to thereby align the yokes 174 to a rotational axis 176 of the second body portion 120. With brief additional reference to FIG. 3, the yokes 174 are configured to receive conventional bearings 178 and a conventional cross-shaped trunnion or spider 180. Accordingly, it will be appreciated that the second body portion 120 and the yoke flange 170 can cooperate to form a portion of a universal joint 182 that couples the torque-limiting coupling 30 to the second propeller shaft 26.

Returning to FIGS. 1 and 2, the second clutch portion 102 can include a second hub portion 190 and a plurality of second clutch plates 192. The second hub portion 190 can be rotary fixed coupled to the second body portion 120 and can include a plurality of longitudinally extending spline members 194. The second clutch plates 192 can include a splined outer perimeter 196 that non-rotatably but axially slidably engages the second hub portion 190 (i.e., the second clutch plates 192 can be splined to the second hub portion 190). The second clutch plates 192 can be interleaved with the first clutch plates 152.

One or both of the first and second clutch portions 100 and 102 can carry a biasing means 200 (or portions thereof) for causing frictional engagement between the first and second clutch plates 152 and 192. In the particular example provided, the biasing means 200 includes a spring, such as one or more wave springs 202 and a pressure plate 204 that are received into a cavity 206 that is defined by the first and second body portions 110 and 120. The pressure plate 204 can be an annular structure having a radially outer edge 208, which can be threaded into the annular hub 160, and a radially inner edge 210 that can slidingly engage a cylindrically-shaped portion 212 of the first body portion 110. The pressure plate 204 can urge the first and second clutch plates 152 and 192 into contact with another and compress the wave spring(s) 202. The axially-directed load exerted by the wave spring(s) 202 causes the first and second clutch plates 152 and 192 to frictionally engage one another to thereby resist relative rotation to limit torque transmission through the torque-limiting coupling 30 to a predetermined torque threshold.

Optionally, a set of seals can be employed to seal the interfaces between the first and second clutch portions 100 and 102 and/or a set of thrust members can be employed to control the endplay between the first and second clutch portions 100 and 102. The set of seals can include a first seal member 250, a second seal member 252 and a third seal member 254. The first seal member 250 can sealingly engage the annular hub 160 and the first hub portion 150 on a first side of the first and second clutch plates 152 and 192. The second and third seal members 252 and 254 can be disposed on a second side of the first and second clutch plates 152 and 192 opposite the first side. The second seal member 252 can sealingly engage a radially outer edge 208 of the pressure plate 204 and the second hub portion 190. The third seal member 254 can sealingly engage the radially inner edge 210 of the pressure plate 204 and the outer edge of the cylindrically-shaped portion 212 of the first body portion 110. The first, second and third seal members 250, 252 and 254 can be any appropriate type of seal and in the particular example provided are 0-rings that are received in respective grooves (not specifically shown) on the first hub portion 150, the pressure plate 204 and the first hub portion 150, respectively. The thrust members can comprise a first thrust member 260 and a second thrust member 262. The first thrust member 260 can be any type of thrust limiting element, such as a shim, a thrust washer or a retaining ring, that can be disposed between the first and second clutch portions 100 and 102 on the first side of the first and second clutch plates 192 to limit movement of the second clutch portion 102 in a first axial direction relative to the first clutch portion 100. The second thrust member 262 can likewise be any type of thrust limiting element, such as a shim, a thrust washer or a retaining ring, that can be disposed between the first and second clutch portions 100 and 102 on the second side of the first and second clutch plates 192 to limit movement of the second clutch portion 102 in a second axial direction (opposite the first axial direction) relative to the first clutch portion 100.

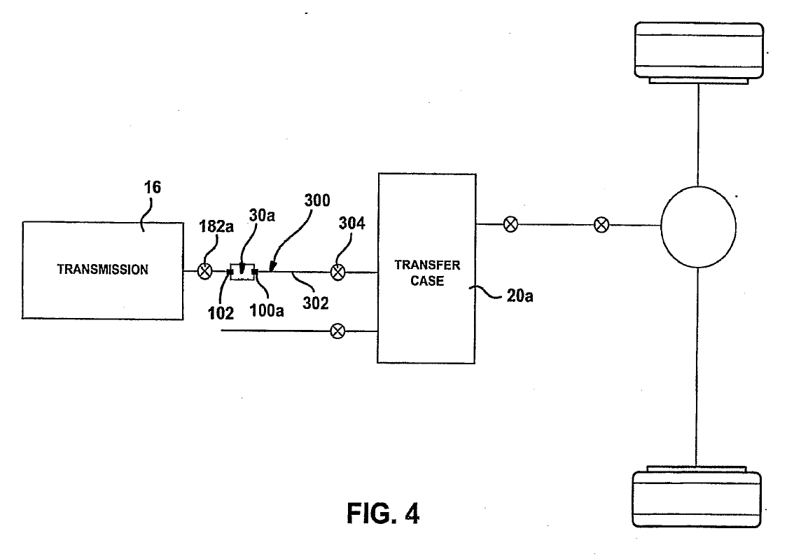

While the torque-limiting coupling has been illustrated as being employed for coupling a propshaft with an output shaft of a transfer case, those of ordinary skill in the art will appreciate that the disclosure has broader applicability. For example, a torque-limiting coupling constructed in accordance with the teachings of the present disclosure can be employed to couple a transmission to another drive line component, such as a propeller shaft, as illustrated in FIG. 4. In this example, the torque-limiting coupling 30a is associated with a propeller shaft 300 that interconnects the transmission 16 to a transfer case 20a. The propeller shaft 300 can include a cylindrical shaft member 302 and a pair of universal joints 182a and 304. The first clutch portion 100a can be generally similar to that first clutch portion 100 (FIG. 2) but fixedly coupled to the cylindrical shaft member 302.

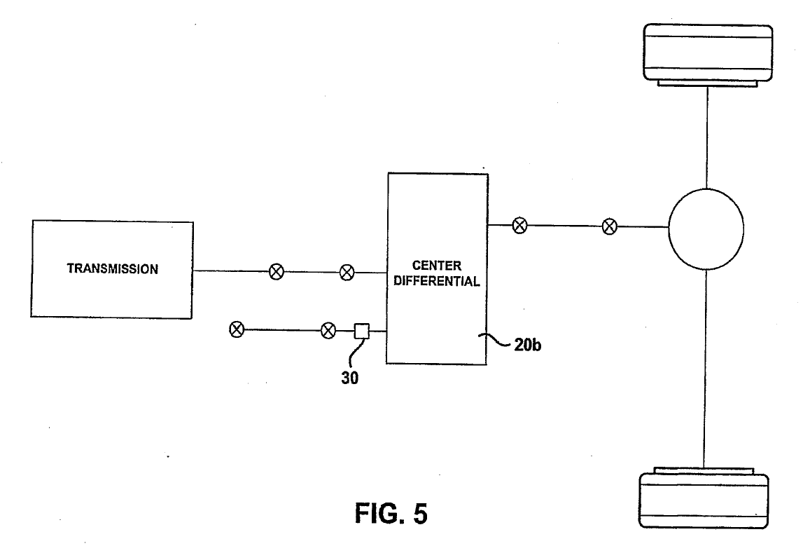

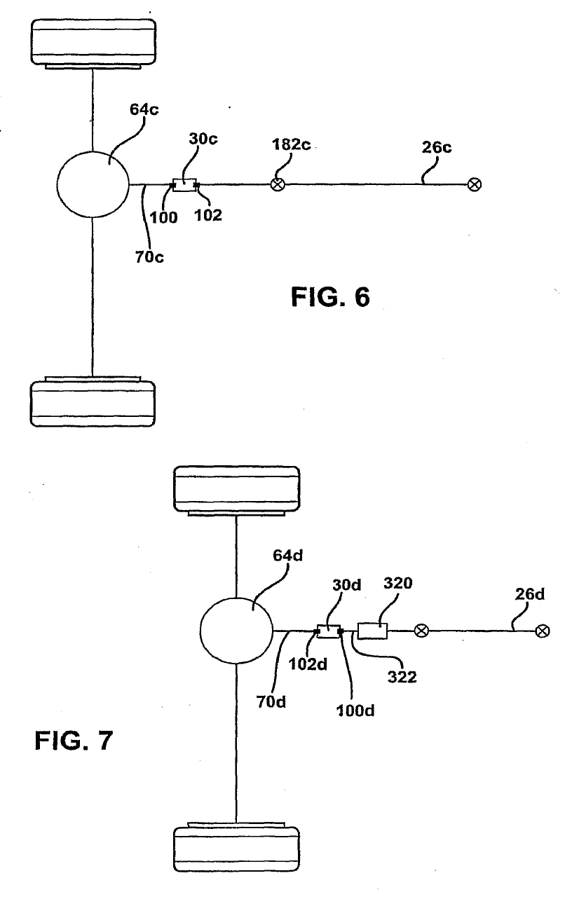

The example of FIG. 5 is generally similar to that of FIG. 1 except that a center differential 20b has been substituted for the transfer case 20 (FIG. 1). The example of FIG. 6 employs a torque-limiting coupling 30c between a differential 64c and another driveline component, such as a propeller shaft 26c. In the example provided, the first coupling portion 100 is coupled to the input pinion 70c of the differential 64c. The example of FIG. 7 employs a torque-limiting coupling 30d between a viscous coupling 320 and another drive line component, such as a differential 64d. In the particular example provided, the first clutch portion 100d can be coupled to an output member 322 of the viscous coupling 320 in a manner that is similar to the manner in which the first clutch portion 100 (FIG. 2) is coupled to the second output shaft 46 (FIG. 2). Similarly, the second clutch portion 102d can be similar to the second clutch portion 102 (FIG. 2) but is adapted to be fixedly but removably coupled to the input pinion 70d rather than to a yoke flange 170 (FIG. 2).

While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out this invention, but that the scope of the present disclosure will include any embodiments falling within the foregoing description and the appended claims.

What is claimed is:

1. A method comprising:
providing a first driveline component having an output member;
coupling the output member to an input portion of a torque limiting coupling; and
coupling an output portion of the torque limiting coupling to an input member of a second driveline component;
wherein the first driveline component is selected from a group consisting of transmissions, propshafts, transfer cases, viscous couplings and differentials;
wherein the second driveline component is selected from a group consisting of propshafts, transfer cases, viscous couplings and differentials; and
wherein the second driveline component is different from the first driveline component.

2. The method of claim 1, wherein the torque limiting coupling includes a friction clutch.

3. The method of claim 2, wherein the input portion includes a first body and a plurality of first clutch plates that are coupled for rotation with the first body, wherein the output portion includes a second body and a plurality of second clutch plates that are coupled for rotation with the second body, and wherein the second clutch plates are interleaved with the first clutch plates.

4. The method of claim 3, wherein the friction clutch is a wet clutch.

5. The method of claim 1, further comprising adjusting the torque limiting clutch to inhibit transfer of rotary power between the input portion and the output portion when a torque transmitted to the torque limiting clutch exceeds a predetermined threshold.

6. The method of claim 5, wherein adjusting the torque limiting clutch includes compressing a spring to develop a force that biases one of the input and output portions into frictional engagement with the other one of the input and output portions.

7. A vehicle driveline comprising:
a first driveline component having a housing and a first power transmitting member;
a second driveline component having a second power transmitting member; and
a torque-limiting coupling having a first clutch portion and a second clutch portion, the first clutch portion including a first body that is removably coupled to the first power transmitting member for rotation therewith, the second clutch portion having a second body that is removably coupled to the second power transmitting member for rotation therewith, the torque-limiting coupling being configured to limit torque transmission between the first and second bodies, wherein the second clutch portion is disposed outside the housing of the first driveline component.

8. The vehicle driveline of claim 7, wherein the torque-limiting coupling includes a friction clutch.

9. The vehicle driveline of claim 8, wherein the first clutch portion further includes a plurality of first clutch plates that are coupled for rotation with the first body, wherein the second clutch portion includes a plurality of second clutch plates that are coupled for rotation with the second body, and wherein the second clutch plates are interleaved with the first clutch plates.

10. The vehicle driveline of claim 9, wherein the friction clutch is a wet clutch.

11. The vehicle driveline of claim 9, wherein the torque-limiting coupling further comprises a spring for biasing the first and second clutch plates into engagement with one another.

12. The vehicle driveline of claim 7, wherein the first driveline component is selected from a group consisting of transmissions, transfer cases, viscous couplings and differentials.

13. The vehicle driveline of claim 7, wherein one of the first power transmitting member and the first clutch portion includes a shaft member having a plurality of longitudinally extending splines and wherein the other one of the first power transmitting member and the first clutch portion defines a toothed aperture that matingly engages the splines of the shaft member.

14. A method comprising:
providing a first driveline component having a first power transmitting member;
directly coupling a first end of a coupling to the first power transmitting member of the first driveline component;
directly coupling a second end of the coupling to a second power transmitting member of a second driveline component, the second power transmitting member being distinct from the first driveline component such that the first and second power transmitting members are not housed in a common housing; and
permitting relative rotation between the first and second ends of the coupling to limit torque transmission between the first and second power transmitting members.

15. The method of claim 14, wherein at least one of the first and second ends is removably coupled to a corresponding one of the first and second power transmitting member.

16. The method of claim 14, wherein the first driveline component is selected from a group consisting of transmissions, propshafts, transfer cases, viscous couplings and differentials.

17. The method of claim 16, wherein the second driveline component is selected from a group consisting of propshafts, transfer cases, viscous couplings and differentials.

18. The method of claim 14, wherein the coupling includes a friction clutch.

19. The method of claim 18, wherein the friction clutch is a wet clutch.

20. The method of claim 14, further comprising adjusting the coupling to permit relative rotation between the first and second ends at a predetermined torque threshold.

21. The method of claim 20, wherein adjusting the coupling includes compressing a spring to develop a force that controls frictional engagement between first and second members that are coupled for rotation with the first and second ends, respectively.
